(19) United States
(12) Patent Application Publication
(10) Pub. No.: US 2018/0045994 A1
(43) Pub. Date: Feb. 15, 2018

(54) LIQUID CRYSTAL DISPLAY

(71) Applicant: Samsung Display Co., Ltd., Yongin-si (KR)

(72) Inventors: Seong Gyu KWON, Suwon-si (KR); Sang Il KIM, Yongin-si (KR); Byung-Gon KUM, Suwon-si (KR); Tae Woo LIM, Yongin-si (KR)

(21) Appl. No.: 15/429,907

(22) Filed: Feb. 10, 2017

(30) Foreign Application Priority Data
Aug. 9, 2016 (KR) 10-2016-0101227

(51) Int. Cl. G02F 1/1339; G02F 1/1333; G02F 1/1335; G02F 1/1343; G02F 1/133; G02F 1/1341

(52) U.S. Cl. CPC G02F 1/1339; G02F 1/13306; G02F 1/1341; G02F 1/133528; G02F 1/13439; G02F 1/133345; G02F 1/133377; G02F 2202/28

(57) ABSTRACT

An exemplary embodiment provides a display device including: a substrate including a display area and a peripheral area; a pixel layer disposed in the display area; a driver layer disposed in the peripheral area; a first optical film disposed above the pixel layer and the driver layer; a second optical film disposed below the substrate; and a sealant disposed between the first optical film and the second optical film to overlap the first optical film and the second optical film in a thickness direction of the substrate.

### CROSS-REFERENCE TO RELATED APPLICATION

This application claims priority to and the benefit of Korean Patent Application No. 10-2016-0101227 filed in the Korean Intellectual Property Office on Aug. 9, 2016, the entire contents of which are incorporated herein by reference.

### BACKGROUND

### (a) Technical Field

This disclosure relates to a display device.

### (b) Description of the Related Art

A display device such as a liquid crystal display or an organic light emitting diode display is manufactured by forming various layers and elements on a substrate. Typically, in the case of the liquid crystal display, a liquid crystal layer is formed between two substrates. A voltage is applied to a pixel electrode and a common electrode of the liquid crystal display to generate an electric field, and polarization of incident light is thereby controlled by adjusting the alignment of liquid crystal molecules of the liquid crystal layer to display an image. In the case of the organic light emitting diode display, excitons generated by combining electrons supplied from a cathode with holes supplied from an anode in an organic emission layer release energy for light emission.

According to a recent technique that has been being developed, a plurality of microcavities having tunnel-type structures are disposed on one substrate, and liquid crystal is injected into the microcavities. Then, a capping layer is used to seal the microcavities to manufacture the liquid crystal display. This liquid crystal display employs one substrate, and thus is weight-light and is advantageous in reducing a bezel width and forming a curved display panel, but may be vulnerable to moisture transmission.

The above information disclosed in this Background section is only for enhancement of understanding of the background of the invention, and therefore it may contain information that does not form the prior art that is already known in this country to a person of ordinary skill in the art.

### SUMMARY

Exemplary embodiments have been made in an effort to provide a display device capable of reducing a peripheral area of the display panel and improving reliability.

An exemplary embodiment provides a display device including: a substrate including a display area and a peripheral area; a pixel layer disposed in the display area; a driver layer disposed in the peripheral area; a first optical film disposed above the pixel layer and the driver layer; a second optical film disposed below the substrate; and a sealant disposed between the first optical film and the second optical film to overlap the first optical film and the second optical film in a thickness direction of the substrate.

A first side surface of the sealant may contact a side surface of the substrate.

A second side surface of the substrate and side surfaces of the first optical film and the second optical film may be in a same plane.

The pixel layer may include a liquid crystal layer disposed in a plurality of microcavities and a roof layer disposed on the liquid crystal layer.

The display device may further include a capping layer disposed above the pixel layer and the driver layer, and the first side surface of the sealant may contact a side surface of the capping layer.

The display device may further include: a first adhesive layer disposed between the capping layer and the first optical film; and a second adhesive layer disposed between the substrate and the second optical film, wherein a top surface of the sealant may contact the first adhesive layer, and a bottom surface of the sealant may contact the second adhesive layer.

At least one of the first optical film and the second optical film may serve as a polarization film.

The driver layer may include a gate driver that includes a plurality of stages and a plurality of signal lines for transferring clock signals to the stages, and the sealant may not overlap the stages and the signal lines.

The display device may further include a transparent electrode layer and an inorganic insulating layer disposed between the capping layer and the driver layer to cover the driver layer.

The display device may further include a pad unit disposed in the peripheral area, and the first optical film may overlap the pad unit in a thickness direction of the substrate.

Another exemplary embodiment provides a display device including: a substrate including a display area and a peripheral area; a pixel layer disposed in the display area; a driver layer disposed in the peripheral area; an optical film disposed above the pixel layer and the driver layer; and a sealant disposed between the optical film and the substrate to overlap the optical film and the substrate in a thickness direction of the substrate.

The display device may further include a capping layer disposed above the pixel layer and the driver layer, and a first side surface of the sealant may contact a side surface of the capping layer.

A second side surface of the sealant and side surfaces of the optical film and the substrate may be in a same plane.

The sealant may have a first portion that contacts the optical film and a second portion that contacts a side surface of the substrate.

The display device may further include an adhesive layer disposed between the capping layer and the optical film, and a surface of the sealant may contact the adhesive layer.

The sealant may have a third portion that contacts the adhesive layer.

The pixel layer may include a liquid crystal layer disposed in a plurality of microcavities and a roof layer disposed on the liquid crystal layer.

The driver layer may include a gate driver that includes a plurality of stages and a plurality of signal lines for transferring clock signals to the stages, and the sealant may overlap the stages and the signal lines.

The display device may further include a transparent electrode layer and an inorganic insulating layer disposed between the capping layer and the driver layer to cover the driver layer.

The display device may further include a pad unit disposed in the peripheral area, and the first optical film may overlap the pad unit in a thickness direction of the substrate.

The optical film may serve as a polarization film.

According to the exemplary embodiments, it is possible to provide a display device capable of preventing moisture penetration while reducing a peripheral area of a display panel, and ameliorating a defective outer appearance caused by a sealant.

### BRIEF DESCRIPTION OF THE DRAWINGS

FIG. 1 is a schematic top plan view illustrating a display device according to an exemplary embodiment of the present invention.

FIG. 2 illustrates a cross-section taken along a line II-II′ of FIG. 1 according to an exemplary embodiment.

FIG. 3 illustrates a manufacturing process of the display device shown in FIG. 2.

FIG. 4 illustrates a cross-section taken along the line II-II′ of FIG. 1 according to an exemplary embodiment.

FIG. 5 illustrates a cross-section taken along the line II-II′ of FIG. 1 according to an exemplary embodiment.

FIG. 6 illustrates a cross-section taken along the line II-II′ of FIG. 1 according to an exemplary embodiment.

FIG. 7 illustrates a cross-section taken along a line VII-VII′ of FIG. 1 according to an exemplary embodiment.

FIG. 8 illustrates a cross-section taken along the line VII-VII′ of FIG. 1 according to an exemplary embodiment.

FIG. 9 illustrates a cross-section taken along the line VII-VII′ of FIG. 1 according to an exemplary embodiment.

FIG. 10 is a layout view illustrating four pixel areas that are adjacently disposed in a display device according to an exemplary embodiment of the present invention.

FIG. 11 illustrates a cross-section taken along a line XI-XI′ of FIG. 10 according to an exemplary embodiment.

FIG. 12 illustrates a cross-section taken along a line XII-XII′ of FIG. 10 according to an exemplary embodiment.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Like reference numerals designate like elements throughout the specification. It will be understood that when an element such as a layer, film, region, or substrate is referred to as being “on” another element, it may be directly on the other element, or intervening elements may also be present. In contrast, when an element is referred to as being “directly on” another element, there are no intervening elements present. Unless otherwise noted in the specification, “overlap” means that at least part of a layer, film, region, or substrate overlaps another element when viewed in a plan view.

A display device according to an exemplary embodiment of the present invention will now be described in detail with reference to the drawings. Although a liquid crystal display is exemplarily employed as a display device, the present invention may be applied to another flat panel display such as an organic light emitting diode display.

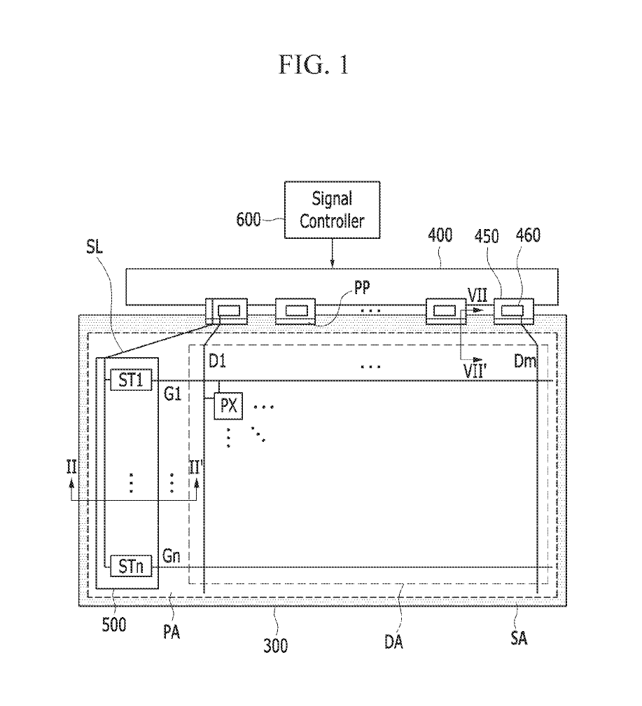

FIG. 1 is a schematic top plan view illustrating a display device according to an exemplary embodiment of the present invention.

Referring to FIG. 1, the display device includes a display panel 300, a data driver 460 serving as a driver for generating and/or processing various signals, and a signal controller 600.

The display panel 300 includes a display area DA for displaying images and a peripheral area PA positioned around the display area DA. In the peripheral area PA, a gate driver 500 for applying gate signals to gate lines G1-Gn and the like is formed. The peripheral area PA includes a sealing area SA in which a sealant for preventing moisture and the like from penetrating the display panel 300 is disposed. The sealing area SA may be disposed to surround an edge of the display panel 300. The display area DA is also referred to as an active area, and the peripheral area PA is also referred to as a non-display area (or an inactive area).

In the display area DA, pixels PX are disposed in a matrix shape, for example. Each of the pixels PX may include a transistor, a liquid crystal capacitor, and a storage capacitor. The liquid crystal capacitor includes a liquid crystal layer. The liquid crystal layer is filled in the microcavities in every pixel area or in every plurality of pixel areas (not illustrated). In the case that an organic light emitting diode display is employed as the display device, each of the pixels PX may include a switching transistor, a driving transistor, a storage capacitor, and a light-emitting device.

In the display area DA, the gate lines G1-Gn and data lines D1-Dm are disposed. The gate lines G1-Gn may extend in a substantially row direction (horizontal direction), and the data lines D1-Dm may extend in a substantially column direction (vertical direction) that crosses the row direction. Each of the pixels may be connected with a gate line and a data line to receive a gate signal and a data signal therefrom.

The data lines D1-Dm of the display area DA receive a data voltage from the data driver 460, which is an integrated circuit chip mounted on a flexible printed circuit film connected with a pad unit PP of the display panel 300. Alternatively, the data driver 460 may be mounted in the peripheral area PA of the display panel 300 in a form of an integrated circuit chip. In FIG. 1, the data driver 460 is illustrated to be positioned at an upper side of the display panel 300. However, the data driver 460 may be positioned at a lower side of the display panel 300.

The gate driver 500 is integrated in the peripheral area PA of the display panel 300. In FIG. 1, the gate driver 500 is illustrated as being positioned in a left peripheral area of the display panel 300. However, the gate driver 500 may be positioned in a right peripheral area thereof or may be positioned in the left and right peripheral areas. The gate driver 500 may be provided in a form of an integrated circuit chip.

The gate driver 500 and the data driver 460 are controlled by the signal controller 600. A printed circuit board (PCB) 400 may be disposed outside the flexible printed circuit film 450 to transfer signals from the signal controller 600 to the data driver 460 and the gate driver 500.

The signals transferred from the signal controller 600 to the gate driver 500 include signals such as vertical start signals and clock signals, as well as signals for supplying voltages of particular levels (e.g., low voltages corresponding to gate-off voltages). According to another exemplary embodiment, the signals transferred from the signal controller 600 to the gate driver 500 may include two or more kinds of vertical start signals, clock signals, and/or low voltages. The gate driver 500 includes stages ST1-STn serving as circuits for generating and outputting gate signals including gate-on voltages and gate-off voltages by using the signals and signal lines SL for transferring the signals to the stages ST1-STn. The stages ST1-STn may be arranged to be subordinately connected with each other in a column direction, and may be referred to as shift registers.

The signal lines SL may be positioned at an outer perimeter of the display area DA, like the stages ST1-STn, and may extend in a substantially column direction. Some signal lines (e.g., signal lines for transferring a low voltage) may be positioned between the stages ST1-STn and the display area DA. Among the signal lines SL, signal lines for transferring clock signals may be most distant from the stages ST1-STn. Although being illustrated as one line in FIG. 1, the signal lines SL may include a number of signal lines corresponding to a number of signals applied to the gate driver 500, or more or less.

A common voltage line (not illustrated) for transferring a common voltage to a common electrode of the display area DA may be positioned in the peripheral area PA around the gate driver 500. Further, a repair line (not illustrated) may be disposed in the peripheral area PA. The repair line may instead be used, for example, to transmit the signal when the data line and the like are broken and cause a defect.

So far, an overall structure of the display device has been discussed. Hereinafter, a structure of the vicinity of the gate driver 500 in which a sealant is disposed will be described in more detail.

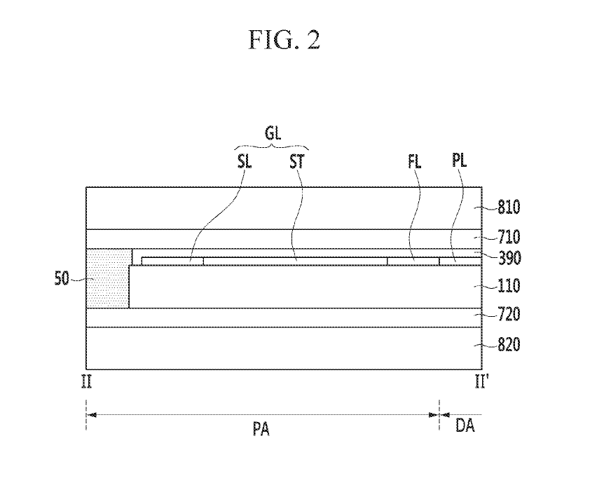

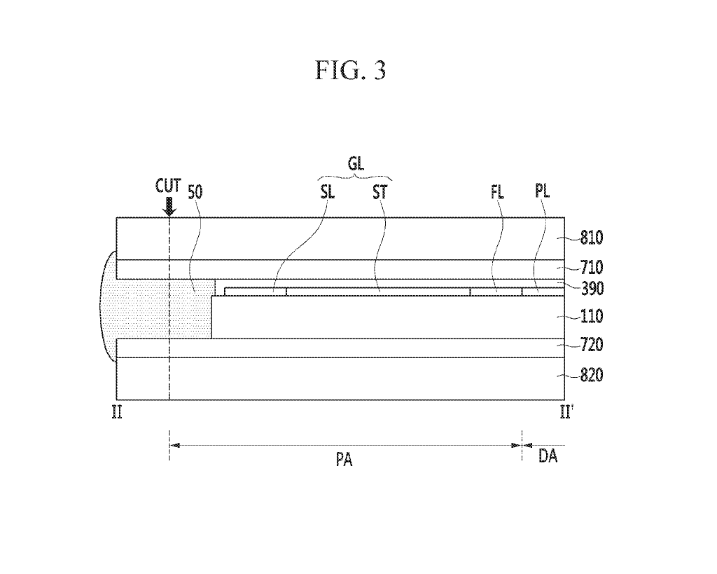

FIG. 2 illustrates a cross-section taken along a line II-II′ of FIG. 1 according to an exemplary embodiment, and FIG. 3 illustrates a manufacturing process of the display device shown in FIG. 2.

To simplify the drawing and to clarify the present invention, in FIG. 2 and FIG. 3, layers in which the gate driver 500 is formed and layers of the display area in which pixels are disposed are respectively illustrated as single layers, which are referred to as a gate driver layer GL and a pixel layer PL. Further, FIG. 1 may also be referred to without special description.

Referring to FIG. 2, the display panel 300 includes a substrate 110, and a gate driver layer GL and a pixel layer PL disposed on the substrate 110. The substrate 110 may be formed of a material such as glass to prevent moisture transmission from below the substrate 110. The substrate 110 may be a flexible substrate formed of a polymer film, and may be formed of, e.g., a plastic such as polyimide, polyamide, or polyethylene terephthalate. In this case, the substrate 110 may include a barrier layer for preventing penetration of moisture and the like, and the barrier layer may include an organic material such as a silicon nitride (SiNx) or a silicon oxide (SiOx).

The gate driver layer GL includes a stage ST and signal lines SL. The display panel 300 includes a fan-out layer FL between the gate driver layer GL and the display area DA. In the fan-out layer FL, some of the gate lines G1-Gn positioned outside the display area DA are disposed. A signal line for transferring a specific level of voltage may be disposed in the fan-out layer FL.

A capping layer 390 is disposed on the gate driver layer GL, the fan-out layer FL, and the pixel layer PL to cover these layers GL, FL, and PL. The capping layer 390 may include an organic material and/or an inorganic material, and may be formed throughout substantially the entire surface of the substrate 110 except for the vicinity of the pad unit PP of the display panel 300. Although not shown, a light blocking member (also referred to as a black matrix) may be formed between the capping layer 390 and the gate driver layer GL and the fan-out layer FL to prevent light leakage (leakage of light from a backlight) or external light reflection by a metal or the like.

A first optical film 810 and a second optical film 820 are respectively disposed above and below the capping layer 390. The first optical film 810 is attached to the capping layer 390 through a first adhesive layer 710 positioned therebelow, and the second optical film 820 is attached to the substrate 110 through a second adhesive layer 720 positioned thereabove. The first adhesive layer 710 and the second adhesive layer 720 may be a pressure sensitive adhesive (PSA) or an optically clear adhesive (OCA). The display device may be postured such that the first optical film 810 of the display panel 300 faces the outside (i.e., a user), and may be positioned such that the second optical film 820 of the display panel 300 faces the outside. When a liquid crystal display is used as the display device, each of the first optical member 810 and the second optical member 820 may be formed of a polarization film.

Basically, the first optical film 810, which covers the display area DA, also covers the gate driver layer GL up to an edge of the substrate 110, and is disposed to extend from an edge of the substrate 110 to the outside of the substrate 110, together with the first adhesive layer 710. Similarly, the second optical film 820 is disposed to extend from an edge of the substrate 110 to the outside of the substrate 110, together with the second adhesive layer 720. A sealant 50 is disposed between extensions of the first optical film 810 and the second optical film 820. Accordingly, the gate driver layer GL may be surrounded by the substrate 110, the first optical film 810, and the sealant 50 to block moisture penetration to the gate driver layer GL from a bottom surface, a top surface, and a side surface by the substrate 110, the first optical film 810 and the first adhesive layer 710, and the sealant 50, respectively.

The moisture penetration may cause corrosion of wires and circuits, and moisture penetrating along interfaces between layers may increase gaps between the layers. According to the present exemplary embodiment, although the display panel 300 includes one substrate 110, and no substrate is covered on the gate driver layer GL, it is possible to effectively prevent the moisture penetration by the optical films 810 and 820 and the sealant 50. Further, since the interface between the capping layer 390 and the sealant 50 through which moisture would easily penetrate are not exposed to the outside, the moisture penetration can be prevented through the interface. Accordingly, although the sealant 50 is formed to have a narrower width, it is possible to block the moisture penetration. Further, it is possible to reduce a width of the peripheral area PA by at least as much as a degree to which the width of the sealant 50 is reduced.

To increase the ability for preventing the moisture transmission, at least one of the first optical film 810 and the first optical film 710 may include a barrier layer including, e.g., an organic material, and the sealant 50 may include a moisture absorbent.

A top surface and a bottom surface of the display panel 300 are respectively confined by the first optical film 810 and the second optical film 820, and the sealant 50 is disposed between the first and second optical films 810 and 820. Accordingly, an outer appearance of the display panel 300 is not deteriorated, and a smooth surface is provided by the first and second optical films 810 and 820. Further, although a lifting phenomenon of a layer such as an inorganic layer occurs in, e.g., the sealing area SA by the action of static electricity, it is covered by the optical films 810 and 820 such that it is not exposed.

The top surface of the sealant 50 may contact the first adhesive layer 710, and the bottom surface thereof may contact the second adhesive layer 720. A side surface of the sealant 50 may contact side surfaces of the substrate 110 and the capping layer 390. Another side surface of the sealant 50 may be positioned in substantially the same plane as those of the first optical film 810 and the second optical film 820. As a result, an externally exposed side surface of the sealant 50 may be aligned or flush with side surfaces of the first optical film 810, the first adhesive layer 710, the second adhesive layer 720, and the second optical film 820 so as to form one plane.

Referring to FIG. 3, such a structure of the sealant 50 may be formed by respectively attaching the first optical film 810 and the second optical film 820 above the capping layer 390 and below the substrate 110 with wide margins and filling the sealant 50 between the first optical film 810 and the second optical film 820 and curing it, and then cut edges of the first optical film 810, the first adhesive layer 710, the sealant 50, the second adhesive layer 720, and the second optical film 820, all together. The sealant 50 that is in a liquid form before the curing may be filled in a space confined by the first adhesive layer 710, the capping layer 390, the substrate 110, and the second adhesive layer 720 by a capillary force. The cutting may be performed by using, e.g., femtosecond laser.

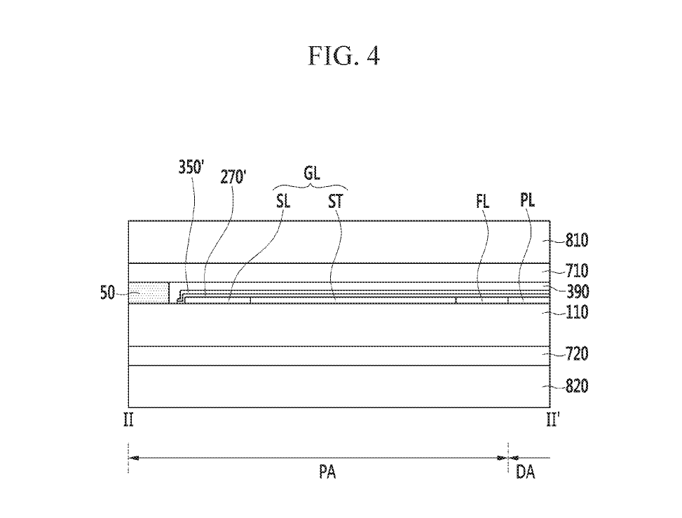

Hereinafter, other exemplary embodiments of the present invention will be described with reference to FIG. 4 to FIG. 6 based on differences with the exemplary embodiment of FIG. 2.

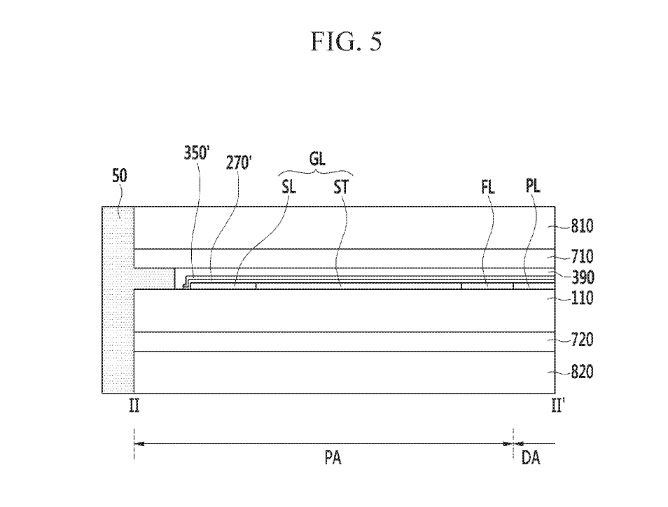

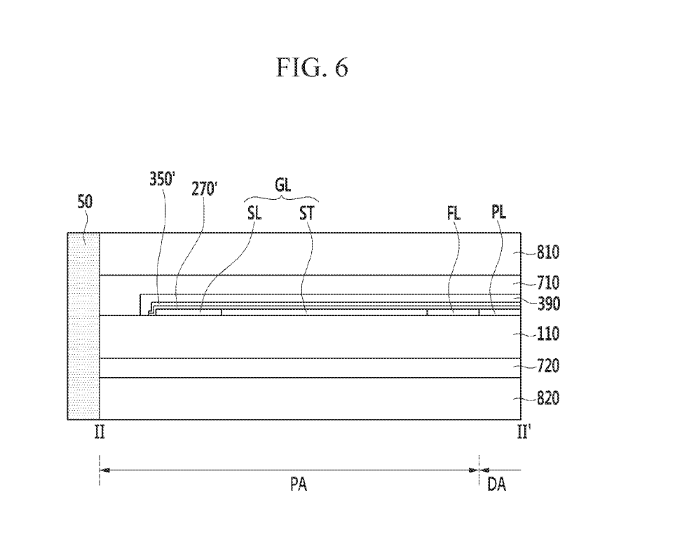

FIG. 4, FIG. 5, and FIG. 6 illustrate a cross-section taken along a line II-II′ of FIG. 1 according to exemplary embodiments, respectively.

Referring to FIG. 4, the gate driver layer GL, the fan-out layer FL, and the pixel layer PL are disposed on the substrate 110, and these layers GL, FL, and PL are covered with the capping layer 390. The first optical film 810 is attached to the capping layer 390 thereabove by using the first adhesive layer 710, and the second optical film 820 is attached to the substrate 110 therebelow by using the second adhesive layer 720. The first optical film 810 completely covers the gate driver layer GL, and a side surface thereof is substantially parallel with a side surface of the substrate 110 on the same plane.

When an organic light emitting diode display is employed as a display device, the capping layer 390 may be a thin film encapsulation layer for preventing penetration of moisture or oxygen from the outside. In the case of the organic light emitting diode display, the first optical film 810 may be an anti-reflective layer, and the second optical film 820 may not be included.

The sealant 50 may be disposed between the first optical film 810 and the substrate 110. A top surface of the sealant 50 may contact the first adhesive layer 710, and a bottom surface thereof may contact the substrate 110. A side surface of the sealant 50 may contact a side surface of the capping layer 390, and another side surface thereof may be substantially parallel with side surfaces of the first optical film 810, the first adhesive layer 710, the substrate 110, the second adhesive layer 720, and the second optical film 820 in the same plane. For example, such a structure of the sealant 50 may be formed by attaching the first optical film 810 and the second optical film 820, by filling the sealant 50 in a space confined by the first adhesive layer 710, the capping layer 390, and the substrate 110 and curing it, and cutting edges of the first optical film 810, the first adhesive layer 710, the sealant 50, the substrate 110, the second adhesive layer 720, and the second optical film 820.

The gate driver layer GL is completely surrounded by the substrate 110, the first optical film 810, and the sealant 50, and thus moisture penetration to the gate driver layer GL may be blocked from a bottom surface thereof by the substrate 110, from a top surface thereof by the first optical film 810 and the first adhesive layer 710, and from a side surface thereof by the sealant 50. Moisture that may penetrate from a lower portion of the gate driver layer GL may be blocked by the substrate 110. Accordingly, the second optical film 820 may be disposed to cover less than the illustrated area, e.g., to such a degree so as to cover the display area DA.

A transparent electrode layer 270′ and an inorganic insulating layer 350′ are disposed between the capping layer 390 and the gate driver layer GL and fan-out layer FL. The transparent electrode layer 270′ may be an electrode layer formed of indium tin oxide (ITO) or indium zinc oxide (IZO), which is used to form a common electrode in the display area DA, and the inorganic insulating layer 350′ may serve as a lower insulating layer between a roof layer and the common electrode, which are described later, in the display area DA and may include an organic material such as a silicon nitride (SiNx) or a silicon oxide (SiOx). The transparent electrode layer 270′ and the inorganic insulating layer 350′ may serve as a barrier layer for blocking moisture penetration to the gate driver layer GL. At least one of the transparent electrode layer 270′ and the inorganic insulating layer 350′ may be omitted. A light blocking member (not illustrated) may be disposed between the capping layer 390 and the gate driver 500 and fan-out layer FL.

Referring to FIG. 5, the sealant 50 is disposed between the substrate 110 and the first optical film 810 as in the exemplary embodiment of FIG. 4. However, the sealant 50 is disposed on side surfaces of the first optical film 810, the substrate 110, and the second optical film 820, unlike in the exemplary embodiment of FIG. 4. Referring to FIG. 6, compared with the exemplary embodiment of FIG. 5, the sealant 50 is disposed on side surfaces of the first optical film 810, the substrate 110, and the second optical film 820, while the first adhesive layer 710 instead of the sealant 50 is disposed between the substrate 110 and the first optical film 810. The side surfaces of the first optical film 810, the first adhesive layer 710, the substrate 110, the second adhesive layer 720, and the second optical film 820 may be substantially parallel with each other in the same plane (e.g., flush with each other). In the exemplary embodiments of FIG. 5 and FIG. 6, the sealant 50 seals the side surface of the display panel, and thus moisture penetration to, e.g., an interface between the first adhesive layer 710 and the sealant 50 or an interface between the substrate 110 and the sealant 50, may be more efficiently prevented.

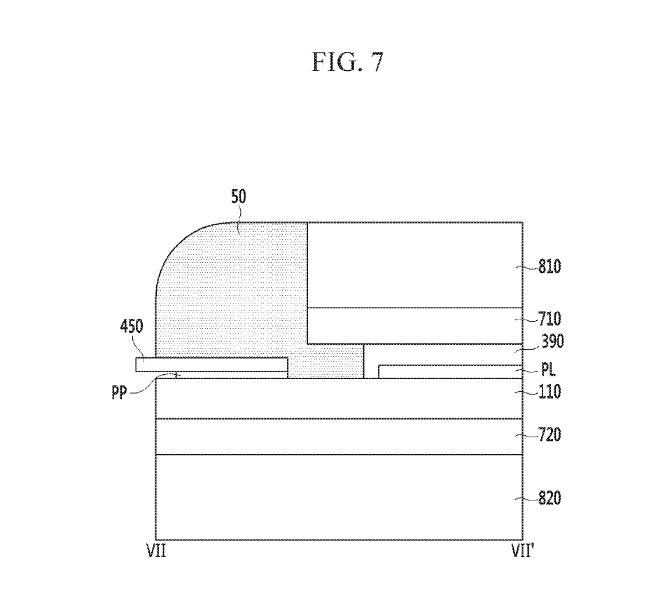

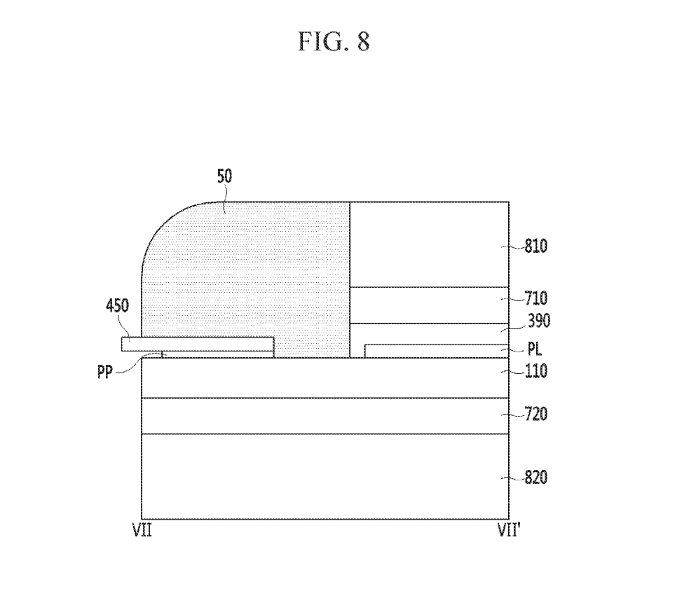

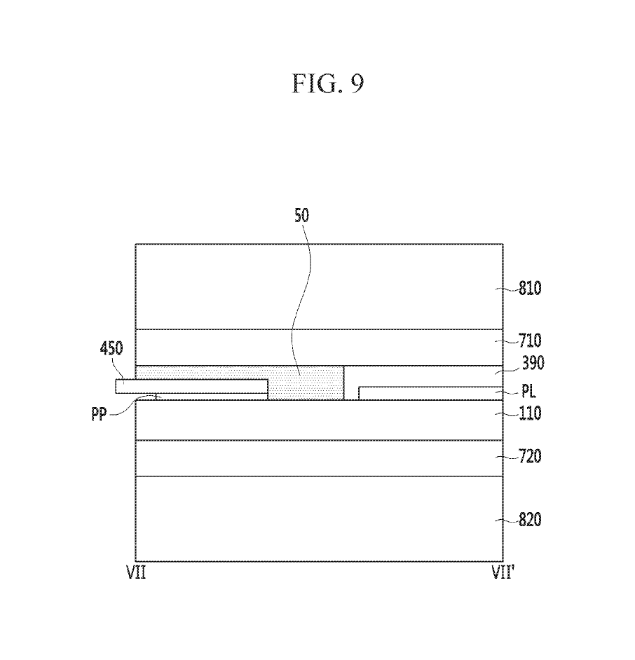

So far the structure for preventing moisture penetration has been described based on the vicinity of the left edge of the display panel 300 in which the gate driver 500 is disposed. However, this structure (particularly, a relationship between the substrate, the capping layer, the optical film, and the sealant) may be applied to another edge of the display panel 300. However, the vicinity of an edge at which the pad unit PP is disposed may require a flexible printed circuit film 450 to be attached thereto, and thus may have a structure that is slightly different from the aforementioned structure. This will be described with reference to FIG. 7, FIG. 8, and FIG. 9.

FIG. 7, FIG. 8 and FIG. 9 illustrate cross-sections taken along a line VII-VII′ of FIG. 1 according to exemplary embodiments, respectively.

Referring to FIG. 7 and FIG. 8, the pad unit PP and the pixel layer PL are disposed on the substrate 110. The capping layer 390 covers the pixel layer PL, but is not disposed on the pad unit PP to which the flexible printed circuit film 450 is bonded. The first optical film 810 is attached to the capping layer 390 thereabove by the first adhesive layer 710, and the second optical film 820 is attached to the substrate 110 therebelow by the second adhesive layer 720. The first optical film 810 is disposed to expose the pad unit PP for bonding of the flexible printed circuit film 450. Accordingly, a side surface of the first optical film 810 may be disposed between the pad unit PP and the capping layer 390. FIG. 7 illustrates an example in which the side surface of the first optical film 810 is disposed closer to the pad unit PP, and FIG. 8 illustrates an example in which the side surface of the first optical film 810 substantially coincides with a side surface of the capping layer 390. The sealant 50 is formed to seal the side surfaces of the first optical film 810, the first adhesive layer 710, and the capping layer 390 above the pad unit PP and the flexible printed circuit film 450. In the exemplary embodiment of FIG. 7, the sealant 50 is also disposed in a space confined by the first adhesive layer 710, the capping layer 390, and the substrate 110.

Referring to FIG. 9, the first optical film 810 covers the pad unit PP, and the side surfaces of the first optical film 810 and the substrate 110 are disposed in substantially the same plane. The sealant 50 may be disposed between the first optical film 810 and the substrate 110, as in the exemplary embodiment of FIG. 4. For example, this structure may be formed by attaching the flexible printed circuit film 450 to the pad unit PP, attaching the first optical film 810 to the capping layer 390 thereabove such that a side surface thereof substantially coincides with the side surface of the substrate 110, and injecting the sealant 50 into a space confined by the substrate 110, the capping layer 390, and the first adhesive layer 710.

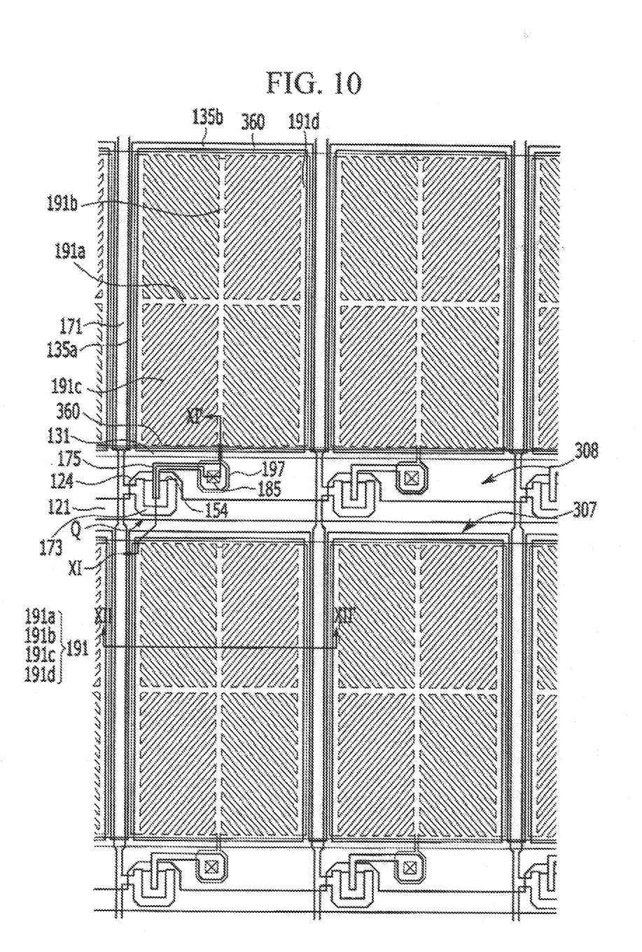

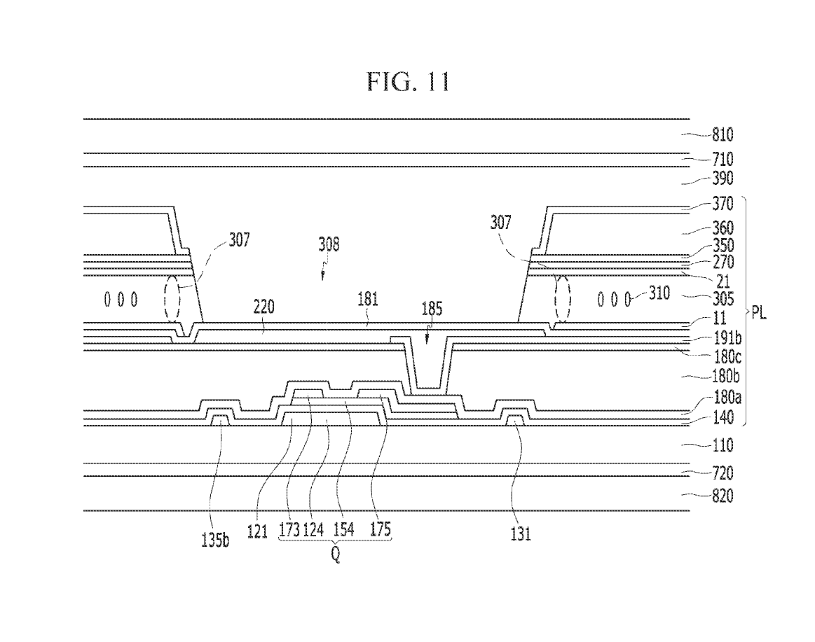

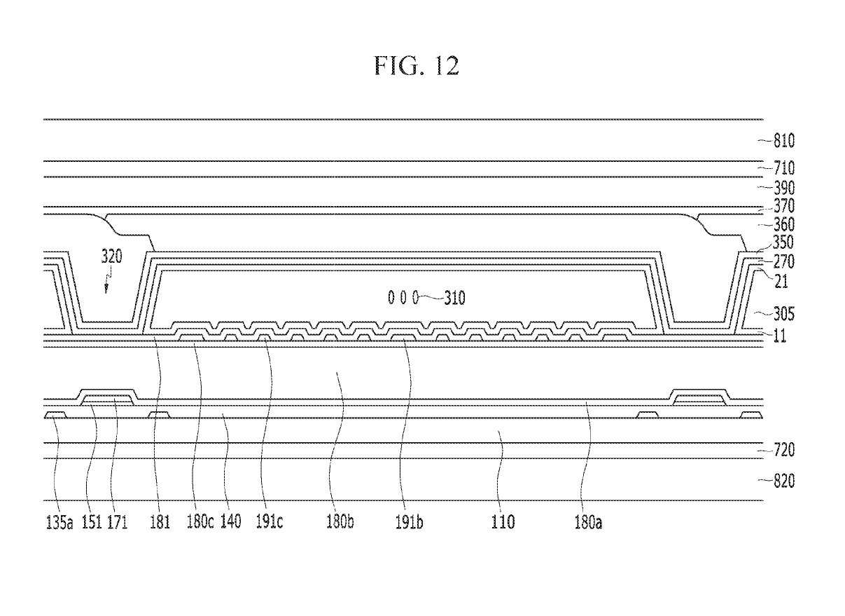

So far, the display device according to an exemplary embodiment of the present invention has been described based on the peripheral area. Hereinafter, the display device according to an exemplary embodiment of the present invention will be described based on the pixel areas with reference to FIG. 10, FIG. 11, and FIG. 12. FIG. 1 to FIG. 9 may also be referred to without special description.

FIG. 10 is a layout view illustrating four pixel areas that are adjacently disposed in a display device according to an exemplary embodiment of the present invention, FIG. 11 illustrates a cross-section taken along a line XI-XI′ of FIG. 10 according to an exemplary embodiment, and FIG. 12 illustrates a cross-section taken along a line XII-XII′ of FIG. 10 according to an exemplary embodiment.

FIG. 10 illustrates a 2×2 portion of the pixel areas, and these pixel areas may be repeatedly arranged up/down and right/left in the display panel in a plan view.

Referring to FIG. 10 to FIG. 12, various layers and elements constituting the display layer PL are disposed on the substrate 110 formed of transparent glass or plastic, the capping layer 390 and the first optical film 810 are disposed on the display layer PL, and the second optical film 820 is disposed below the substrate 110.

Specifically, a gate line 121 and a storage electrode line 131 are disposed on the substrate 110. A gate electrode 124 is formed at a portion of the gate line 121. The storage electrode line 131 is mainly extended in a row direction to transfer a predetermined voltage such as a common voltage. The storage electrode line 131 may include a pair of vertical portions 135a that are extended in a substantially column direction, and a horizontal portion 135b that connects ends of the pair of vertical portions 135a. The gate line 121, the gate electrode 124, and the storage electrode line 131 may be formed of a same material at a same layer, and are referred to as a gate conductor. The gate conductor may be formed of a metal such as aluminum (Al), silver (Ag), copper (Cu), molybdenum (Mo), chromium (Cr), tantalum (Ta), or titanium (Ti), or an alloy thereof.

A gate insulating layer 140 is disposed on the gate conductor. A semiconductor 151 and a semiconductor 154 are disposed on the gate insulating layer 140 such that the semiconductor 151 is positioned below a data line 171, and the semiconductor 154 is positioned below a source electrode 173 and the drain electrode 175 and is positioned at a channel portion of a transistor Q.

A data line 171 and a drain electrode 175 connected with the source electrode 173 are disposed on the semiconductors 151 and 154 and the gate insulating layer 140. The data line 171, the source electrode 173, and the drain electrode 175 may be formed of a same material at a same layer, and are referred to as a data conductor. The data conductor may be formed of a metal such as aluminum, copper, molybdenum, chromium, tantalum, or titanium, or an alloy thereof.

Ohmic contacts (not shown) may be disposed between the data conductor and the semiconductors 151 and 154.

The gate electrode 124, the source electrode 173, and the drain electrode 175 constitute the transistor Q together with the semiconductor 154. Meanwhile, in the peripheral area PA, the stages ST1-STn of the gate driver 500 may include transistors having a stacking structure that is the same as the transistors of the pixel areas.

A first passivation layer 180a is disposed on the data conductor. The first passivation layer 180a may include an organic material such as a silicon nitride and a silicon oxide. A second passivation layer 180b and a third passivation layer 180c are disposed on the first passivation layer 180a. The second passivation layer 180b may include an organic material, and the third passivation layer 180c may include an inorganic material. One or two layers of the first passivation layer 180a, the second passivation layer 180b, and the third passivation layer 180c may be omitted.

A contact hole 185 is formed to extend through the first passivation layer 180a, the second passivation layer 180b, and the third passivation layer 180c, and the drain electrode 175 is connected with a pixel electrode 191 disposed on the third passivation layer 180c through the contact hole 185. The pixel electrode 191 may be formed of a transparent conductive material such as indium tin oxide (ITO) or indium zinc oxide (IZO). The pixel electrode 191 has an overall shape that is quadrangular, and includes a cross-shaped stem including a horizontal stem 191a and a vertical stem 191b that crosses the horizontal stem 191a. The pixel electrode 191 is divided into four subregions by the horizontal stem 191a and the vertical stem 191b, and each of the subregions includes a plurality of minute branches 191c. The pixel electrode 191 may further include an outer stem 191d that contacts the minute branches 191c at an outer perimeter.

The pixel electrode 191 includes an extension 197, which is connected with a lower end of the vertical stem 191b and has a larger area than the vertical stem 191b, and is connected with the drain electrode 175 through the contact hole 185 in the extension 197 to receive a data voltage from the drain electrode 175.

The foregoing description of the transistor Q and the pixel electrode 191 is merely an example, and a structure of the thin film transistor and a design of the pixel electrode may be modified to improve side visibility.

A light blocking member 220 is disposed to cover a region where the transistor Q is disposed on the pixel electrode 191. The light blocking member 220 may be disposed along an extending direction of the gate line 121. Meanwhile, in the peripheral area PA, the light blocking member 220 may be disposed to cover the gate driver layer GL and the like. An insulating layer 181 formed of a silicon nitride or a silicon oxide may be disposed on the light blocking member 220.

A lower alignment layer 11 is disposed on the pixel electrode 191, and an upper alignment layer 21 is disposed at such a portion so as to face the lower alignment layer 11. A microcavity 305 is formed between the lower alignment layer 11 and the upper alignment layer 21. A liquid crystal material including liquid crystal molecules 310 is injected into the microcavity 305 to form a liquid crystal layer. The microcavity 305 may be formed along a column direction. An alignment material for forming the alignment layers 11 and 21 and the liquid crystal material including the liquid crystal molecules 310 may be injected into the microcavity 305. The microcavity 305 includes an entrance region 307 for such injecting. Meanwhile, the lower alignment layer 11 and the upper alignment layer 21 are merely distinguished depending on a position. As shown in FIG. 12, the lower alignment layer 11 and the upper alignment layer 21 may be connected with each other along a side surface of the microcavity 305.

The microcavity 305 may be divided into a plurality of microcavities 305 in the row direction by a plurality of trenches 308 that are disposed at such a portion to overlap the gate line 121, and the microcavities 305 may be formed in the column direction. Further, the microcavity 305 may be divided into a plurality of microcavities 305 in a horizontal direction by a partition 320 to be described later, and the microcavities 305 may be formed in the row direction in which the gate line 121 is extended. Each of the microcavities 305 may correspond to one or more pixel areas.

A common electrode 270 is disposed on the upper alignment layer 21, and a lower insulating layer 350 is disposed on the common electrode 270. The common electrode 270 receives a common voltage and generates an electric field together with the pixel electrode 191 to which a data voltage is applied to determine a direction in which the liquid crystal molecules 310 disposed in the microcavity 305 between the two electrodes are inclined. The common electrode 270 constitutes a capacitor together with the pixel electrode 191 to maintain an applied voltage even after the transistor is turned off. The lower insulating layer 350 serves as an inorganic insulating layer formed of a silicon nitride or a silicon oxide. Meanwhile, each of the common electrode 270 and the lower insulating layer 350 may be formed in the peripheral area PA as the transparent electrode layer 270′ and an inorganic insulating layer 350′ to serve as a barrier layer for blocking moisture penetration to the gate driver layer GL.

An example in which the common electrode 270 is disposed above the microcavity 305 is illustrated. However, the common electrode 270 may be disposed below the microcavity 305 (accordingly, below the liquid crystal layer), thereby accomplishing liquid crystal driving according to a coplanar electrode (CE) mode.

A roof layer 360 is disposed on the lower insulating layer 350. The roof layer 360 plays a supporting role in forming the microcavity 305, which is a space formed between the pixel electrode 191 and the common electrode 270. The roof layer 360 may include a photoresist, or other organic materials. Alternatively, the roof layer 360 may be formed as a color filter. In this case, as shown in FIG. 12, color filters of respective different colors may overlap the partition 320

The partition 320 is disposed between the microcavities 305 adjacent in the row direction. The partition 320 serves to fill separated spaces in the row direction. The partition 320 may be disposed in a direction in which the data line 171 is extended, to partition or define the microcavity 305. The roof layer 360 may include an organic material.

An upper insulating layer 370 is disposed on the roof layer 360. The upper insulating layer 370 may be formed of an inorganic material such as a silicon nitride or a silicon oxide. The upper insulating layer 370 may also be disposed in the peripheral area PA to serve as a barrier layer.

A capping layer 390 is disposed on the upper insulating layer 370. The capping layer 390 may also be disposed on the trenches 308 to cover the entrance region 307 of the microcavities 305 exposed by the trenches 308. The capping layer 390 may include an organic material or an organic material. The capping layer 390 may also be disposed in the peripheral area PA. For example, the capping layer 390 may cover an entire area of the substrate 110 except for the pad unit PP and the sealing area SA.

The first adhesive layer 710 and the first optical film 810 are disposed above the capping layer 390, and the second adhesive layer 720 and the second optical film 820 are disposed below the substrate 110. The first optical film 810 and the second optical film 820 not only serve to polarize light introduced into the display panel in, e.g., a liquid crystal display or an organic light emitting diode display, but also serve to prevent moisture penetration to the display panel together with the sealant 50 in the peripheral area PA with the same configuration as the aforementioned exemplary embodiments of the present invention.

While this invention has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a substrate including a display area and a peripheral area;
a pixel layer disposed in the display area;
a driver layer disposed in the peripheral area;
a first optical film disposed above the pixel layer and the driver layer;
a second optical film disposed below the substrate; and
a sealant disposed between the first optical film and the second optical film, to overlap the first optical film and the second optical film in a thickness direction of the substrate.

2. The display device of claim 1, wherein a first side surface of the sealant contacts a side surface of the substrate.

3. The display device of claim 2, wherein a second side surface of the substrate and side surfaces of the first optical film and the second optical film are in a same plane.

4. The display device of claim 2, wherein the pixel layer includes a liquid crystal layer disposed in a plurality of microcavities and a roof layer disposed on the liquid crystal layer.

5. The display device of claim 2, further comprising
a capping layer disposed above the pixel layer and the driver layer,
wherein the first side surface of the sealant contacts a side surface of the capping layer.

6. The display device of claim 5, further comprising:
a first adhesive layer disposed between the capping layer and the first optical film; and
a second adhesive layer disposed between the substrate and the second optical film,
wherein a top surface of the sealant contacts the first adhesive layer, and a bottom surface of the sealant contacts the second adhesive layer.

7. The display device of claim 1, wherein at least one of the first optical film and the second optical film serves as a polarization film.

8. The display device of claim 7, wherein the driver layer includes a gate driver that includes a plurality of stages and a plurality of signal lines for transferring clock signals to the stages, and
the sealant does not overlap the stages and the signal lines.

9. The display device of claim 5, further comprising
a transparent electrode layer and an inorganic insulating layer disposed between the capping layer and the driver layer to cover the driver layer.

10. The display device of claim 1, further comprising
a pad unit disposed in the peripheral area,
wherein the first optical film overlaps the pad unit in a thickness direction of the substrate.

11. A display device comprising:
a substrate including a display area and a peripheral area;
a pixel layer disposed in the display area;
a driver layer disposed in the peripheral area;
an optical film disposed above the pixel layer and the driver layer; and
a sealant disposed between the optical film and the substrate to overlap the optical film and the substrate in a thickness direction of the substrate.

12. The display device of claim 11, further comprising
a capping layer disposed above the pixel layer and the driver layer,
wherein a first side surface of the sealant contacts a side surface of the capping layer.

13. The display device of claim 12, wherein a second side surface of the sealant and side surfaces of the optical film and the substrate are in a same plane.

14. The display device of claim 11, wherein the sealant has a first portion that contacts the optical film and a second portion that contacts a side surface of the substrate.

15. The display device of claim 1, further comprising
an adhesive layer disposed between the capping layer and the optical film,
wherein a surface of the sealant contacts the adhesive layer.

16. The display device of claim 15, wherein the sealant has a third portion that contacts the adhesive layer.

17. The display device of claim 11, wherein the pixel layer includes a liquid crystal layer disposed in a plurality of microcavities and a roof layer disposed on the liquid crystal layer.

18. The display device of claim 11, wherein the driver layer includes a gate driver that includes a plurality of stages and a plurality of signal lines for transferring clock signals to the stages, and
the sealant does not overlap the stages and the signal lines.

19. The display device of claim 11, further comprising
a transparent electrode layer and an inorganic insulating layer disposed between the capping layer and the driver layer to cover the driver layer.

20. The display device of claim 11, wherein the optical film serves as a polarization film.
